(19) United States
(12) Patent Application Publication
(10) Pub. No.: US 2025/0057719 A1
(43) Pub. Date: Feb. 20, 2025

(54) MUSCLE STRENGTHENING DEVICE

(71) Applicant: Thera Logics Inc., Warren, OH (US)

(72) Inventors: Daniel Stein, Warren, OH (US); Davide Piovesan, Erie, PA (US); Shubhankar Desai, Garner, NC (US)

(21) Appl. No.: 18/795,755

(22) Filed: Aug. 6, 2024

Related U.S. Application Data
(60) Provisional application No. 63/532,744, filed on Aug. 15, 2023.

(51) Int. Cl. A61H 1/02

(52) U.S. Cl. CPC A61H 1/024; A61H 2201/123; A61H 2201/5007; A61H 2201/5061; A61H 2201/5064; A61H 2201/5084

(57) ABSTRACT

A muscle strengthening device including a brace having a proximal limb section and a distal limb section, wherein the distal limb section is pivotally connected to the proximal limb section. The device has at least one actuator to move the distal limb section relative to the proximal limb section, and a controller for controlling operation of the at least one actuator.

### RELATED APPLICATIONS

This application claims the benefit of U.S. Provisional Application No. 60/532,744 filed Aug. 15, 2023, which is hereby fully incorporated herein by reference.

### FIELD OF THE INVENTION

The present invention relates generally to the field of muscle strengthening, and more particularly to a device suitable for eccentric muscle strengthening.

### BACKGROUND OF THE INVENTION

Eccentric muscle strengthening (also known as “eccentric training”) is a type of strength training that involves using the target muscles to control weight as it moves in a downward motion. An eccentric contraction is a form of muscle contraction where the muscle lengthens as tension is produced. An eccentric muscle contraction occurs when a force applied to the muscle exceeds the momentary force produced by the muscle, thereby resulting in the forced lengthening of the muscle-tendon system. In other words, an eccentric muscle contraction occurs when the force of an external load is greater than the force generated by a person's muscle. A concentric contraction is a form of muscle contraction where the muscle shortens as tension is produced. Accordingly, a concentric muscle contraction occurs when the force of an external load is less than the force generated by a person's muscle.

Eccentric training involves repetition of eccentric exercises that result in eccentric muscle contractions. Such exercises are frequently used in rehabilitation and athletic training. In an eccentric exercise, a force is exerted against an overloading counterforce moving in the opposite direction. For example, in relation to a patient's knee, an eccentric exercise could involve the patient exerting their hamstring muscles to try to bend their knee while an overloading counterforce slowly moves the joint in the opposite direction (extension), or vice versa.

Access to effective rehabilitative techniques for eccentric muscle strengthening and assistive devices is often limited due to cost and other factors, including the distance required to travel to a rehabilitation clinic. Other techniques for eccentric training exist, but require significant guidance by a clinician and may not be as effective. Such equipment can also be difficult for a patient to effectively use to achieve an eccentric overloading force. These drawbacks may lead to dissatisfaction, impaired function, and re-injuries.

Current methods of eccentric training include lengthened-state eccentric muscle exercises using expensive, bulky, and non-portable devices that are not practical for use in a non-clinical or home environment. There are some significant drawbacks to existing muscle strengthening devices. In this regard, such existing devices provide motion around a hinge, and therefore, may rotate in a dissimilar plane as an arm or a leg. Moreover, many existing muscle strengthening devices lack the ability to elevate the proximal portion of a leg above the horizontal for lengthened-state eccentric exercises.

Accordingly, there is a need for a muscle strengthening device that rotates about a migrating medial-lateral axis, or the evolute, thereby allowing rotation in a more similar plane as the joint of interest. There is also a need for a muscle strengthening device that allows a patient to be in varying degrees of hip flexion, while the knee is flexed and extended, thereby allowing for targeted recovery of an injury and prevention of hamstring strains.

Despite the overall effectiveness of total knee replacements and ACL surgery, patients can be at risk for re-injury, falls, or dissatisfaction with their function. Re-injury rates are high in both anterior cruciate ligament (ACL) and hamstring muscle injuries. Eccentric training can be used to provide exercises that are effective for reducing the risk of re-injury. After an ACL operation, patients may experience a loss of knee extension which may contribute to functional deficits and increased risk of knee osteoarthritis, due to abnormal joint loading. These patients, in addition to eccentric training, may also benefit from a gait aid/assistive device to help achieve terminal knee extension during gait.

Patients with osteoarthritis and those who have undergone a total knee replacement operation may have strength deficits in their quadriceps and hamstrings of 50% to 60%, and this deficit may be present for years after their operation. This weakness results in slower gait speeds which has been associated with increased fall risks. Eccentric training can be an effective way of strengthening muscles around all joints. These patients may also have limited knee extension during gait, even without a mechanical constraint. Therefore, such patients may benefit from an assistive brace to achieve terminal knee extension during gait.

Eccentric training has been found to be effective when applied to a variety of joints and to non-orthopedic conditions. In this regard, when eccentric training has been used by patients with COPD, they have been able to work harder for the same metabolic demand, with improved tolerance and less dyspnea. In addition, eccentric training has helped patients with Parkinson's disease improve bradykinesia and quality of life scores. Furthermore, cerebral palsy patients using eccentric exercises at the elbow have been found to have fewer co-contractions.

In view of the foregoing, it can be seen that there are numerous medical conditions where a patient may benefit from a muscle strengthening device to aid their function, in addition to rehabilitation.

Active-assistive training is another area which can be improved using rehabilitative devices, such as muscle strengthening devices. One of the most common impairments following a stroke is upper limb hemiparesis, which refers to weakness on one side of the body. This weakness can significantly impact a person's ability to perform daily activities and can lead to functional limitations. Rehabilitation therapy plays a crucial role in improving motor functions and skills, reducing muscular spasticity, and addressing joint stiffness in stroke survivors. However, post-stroke rehabilitation is often interrupted due to muscle weakness and fatigue, thus making effective guided rehabilitation devices necessary.

Knee buckling is a condition where the knee joint slips and causes sudden pain and potentially a fall. This condition affects nearly 12% of adults between the ages of 36 and 94. This is another condition that can benefit from eccentric training, active-assistive motion and/or a knee brace that stops buckling by utilizing a magnetorheological (MR) fluid. MR is a “smart fluid” that increases viscosity when in the presence of a magnetic field.

The present invention provides a muscle strengthening device for use with a wide variety of joints in connection with both orthopedic and non-orthopedic conditions, the present invention overcoming drawbacks and deficiencies of existing muscle strengthening devices.

### SUMMARY OF THE INVENTION

In accordance with the present invention, there is provided a muscle strengthening device comprising: a brace including: (a) a proximal limb section including an upper band adapted to attach to a user's limb; and (b) a distal limb section including a lower band adapted to attach to a user's limb, wherein the distal limb section is pivotally connected with the proximal limb section; and at least one actuator for moving the distal limb section relative to the proximal limb section.

An advantage of the present invention is the provision of a muscle strengthening device the enables eccentric muscle exercises to be conveniently performed outside of a medical/rehabilitation facility.

Another advantage of the present invention is the provision of a muscle strengthening device that allows therapeutic exercises to be moved to a more convenient/economic venue for care of a patient.

Another advantage of the present invention is the provision of a muscle strengthening device that is easy to use, safe, progressive, and controlled to introduce eccentric exercises into post-operative care, thereby allowing a patient to focus on strength training using eccentric exercises, while eliminating the need for a partner to achieve better strength symmetry between limbs.

Still another advantage of the present invention is the provision of a muscle strengthening device that allows flexion-extension, prono-supination, and internal-external rotation movements.

Still another advantage of the present invention is the provision of a muscle strengthening device that eliminates the need for bulky and costly equipment that lacks portability.

Still another advantage of the present invention is the provision of a muscle strengthening device that is adaptable for use with an existing lower or upper limb brace.

A still further advantage of the present invention is the provision of a muscle strengthening device that provides a simple user interface.

These and other advantages will become apparent from the following description of illustrated embodiments taken together with the accompanying drawings and the appended claims.

### BRIEF DESCRIPTION OF THE DRAWINGS

The invention may take physical form in certain parts and arrangement of parts, one or more embodiments of which will be described in detail in the specification and illustrated in the accompanying drawings which form a part hereof, and wherein:

FIG. 1 is a perspective view of a brace of a muscle strengthening device, according to an embodiment of the present invention;

FIG. 2 is a perspective view of the brace of FIG. 1, with an actuator according to a first embodiment attached thereto;

FIG. 3 is a perspective view of the brace of FIG. 1, with an actuator according to a second embodiment attached thereto;

FIG. 3A is a side view of the actuator illustrated in FIG. 3;

FIG. 3B is a perspective view of the actuator illustrated in FIGS. 3 and 3A, wherein the actuator of FIG. 3 is configured in a reverse orientation;

FIG. 4 is a perspective view of a support member of upper and lower bands of the brace shown in FIG. 1;

FIG. 5 is a perspective view of a strap of upper and lower bands of the brace shown in FIG. 1;

FIG. 6 is a perspective view of a tilting device according to an embodiment of the present invention, the tilting device shown attached to the brace illustrated in FIG. 3;

FIGS. 7 and 8 are perspective views of the tilting device shown in FIG. 6;

FIG. 8A is a perspective view of the tilting device with locking element;

FIG. 9 is a front view of an alternative embodiment of the tilting device;

FIG. 9A is a perspective view of another alternative embodiment of the tilting device;

FIG. 10 is a perspective view of the muscle strengthening device including the brace and actuator as shown in FIG. 2 and the tilting device as shown in FIG. 9, the muscle strengthening device shown placed on a support surface of a chair;

FIG. 11 is a side view of the muscle strengthening device of FIG. 10 as mounted to a user's leg, wherein the user is seated on a support surface of a chair; and

FIG. 12 is a block schematic diagram of the muscle strengthening device according to an embodiment of the present invention.

### DETAILED DESCRIPTION OF THE INVENTION

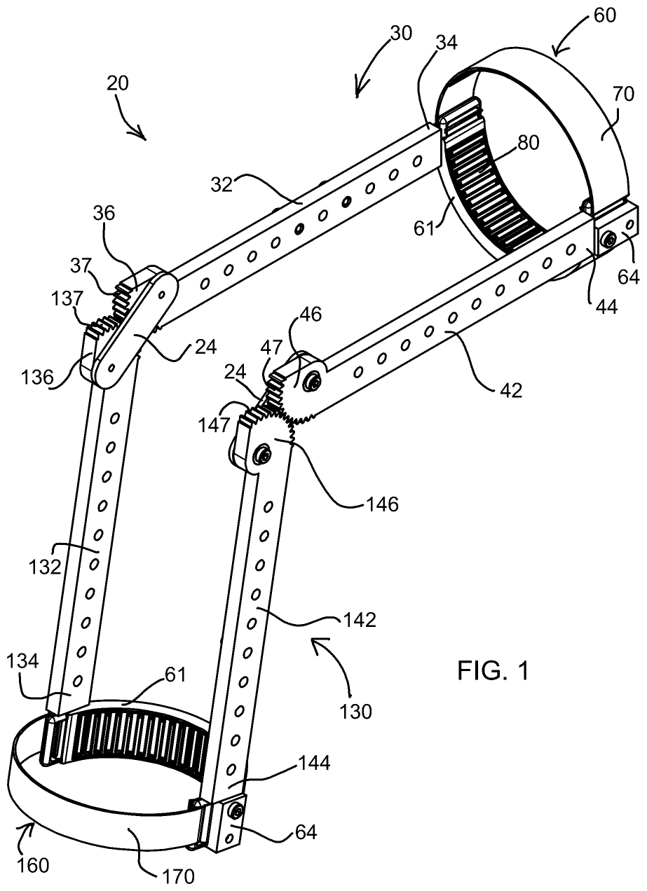

Referring now to the drawings wherein the showings are for the purposes of illustrating embodiments of the invention only and not for the purposes of limiting same, FIG. 1 shows a perspective view of a brace 20 of a muscle strengthening device, according to an embodiment of the present invention. The illustrated embodiment of brace 20 is configured for coupling to a leg. Brace 20 is generally comprised of a proximal limb section 30 attachable to the thigh, and a distal limb section 130 attachable to the calf. Proximal limb section 30 and distal limb section 130 are joined together such that they rotate relative to each other at an axis of rotation, as will be explained below. It is contemplated that brace 20 may also be adapted for attachment to an arm in accordance with an alternative embodiment of the present invention.

In accordance with the illustrated embodiment, proximal limb section 30 includes a pair of elongated upper links 32, 42. Upper link 32 has an upper end 34 and a lower end 36. Likewise, upper link 42 has an upper end 44 and a lower end 46. Proximal limb section 30 also includes an upper band 60 for coupling proximal limb section 30 to a thigh. Upper band 60 attaches to upper ends 34 and 44, as will be described below.

Distal limb section 130 includes a pair of elongated lower links 132, 142. Lower link 132 has a lower end 134 and an upper end 136. Likewise, lower link 142 has a lower end 144 and an upper end 146. Distal limb section 130 also includes a lower band 160 for coupling distal limb section 130 to a calf. Lower band 160 attaches to lower ends 134 and 144, as will be described below.

When upper brace 30 is coupled to the thigh of the right leg and lower brace 130 is coupled to the calf of the right leg, links 32 and 132 will be located on the lateral side of the right knee, and links 42 and 142 will be located on the medial side of the right knee. Similarly, when upper brace 30 is coupled to the thigh of the left leg and lower brace 130 is coupled to the calf of the left leg, links 32 and 132 will be located on the medial side of the left knee and links 42 and 142 will be located on the lateral side of the left knee.

In the illustrated embodiment of the present invention, lower ends 36, 46 of upper links 32, 42 include a cam portion having gear teeth 37, 47. Likewise, upper ends 136, 146 of lower links 132, 142 include a cam portion having gear teeth 137, 147. Lower end 36 of upper link 32 and upper end 136 of lower link 132 are pivotally connected by a connecting member 24, such that gear teeth 37 mate with gear teeth 137. Likewise, lower end 46 of upper link 42 and upper end 146 of lower link 142 are pivotally connected by a connecting member 24 such that gear teeth 47 mate with gear teeth 147. Connecting members 24 allow rotational movement of upper link 32 relative to lower link 132, and rotational movement of upper link 42 relative to lower link 142. Accordingly, the angle between proximal limb section 30 and distal limb section 130 changes as a result of the rotational movement. As links 32, 42 and links 132, 142 rotate relative to each other, gear teeth 37, 137 and gear teeth 47, 147 remain engaged to form a flexion-extension joint. The meshed gear teeth 37, 137 and meshed gear teeth 47, 147 allow synchronized motion of links 32, 132 and links 42, 142, and allow natural motion of the knee joint.

In the illustrated embodiment, connecting members 24 are connecting to links 32, 132, 42, and 142 by a fastener, such as an M4 socket head bolt. Furthermore, links 32, 42, 132, 142 include a plurality of mounting holes according to the illustrated embodiment of the present invention.

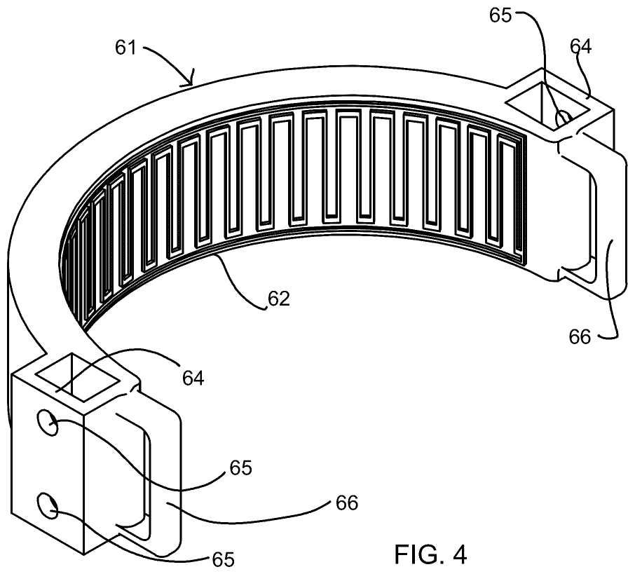

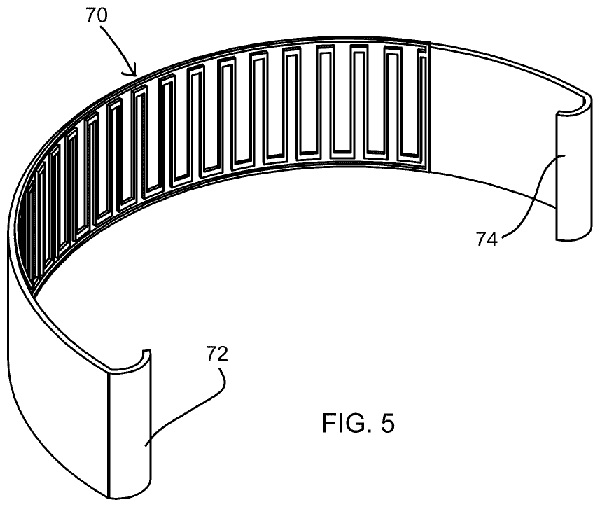

In the illustrated embodiment of the present invention, upper band 60 and lower band 160 are substantially the same. Both are comprised of a U-shaped support member 61 (as shown in FIG. 4) and a U-shaped strap 70 (as shown in FIG. 5). Referring now to FIG. 4, U-shaped support member 61 includes a receiving portion 64 located at opposite ends of support member 61. Each receiving portion 64 includes a recess dimensioned to receive an end of a link. For upper band 60, receiving portions 64 receive upper ends 34 and 44. For lower band 160, receiving portion 64 receive lower ends 134 and 144 In the illustrated embodiment, receiving portions 64 also include one or more fastening holes 65 dimensioned to receive a suitable fastener (e.g., a socket head bolt) for fixing links to support member 61, as seen in FIG. 1.

A strap loop 66 extends from each receiving portion 64. Strap loops 66 are dimensioned to receive respective first and second ends 72, 74 of strap 70, which is shown in FIG. 5. Straps 70 are attached to support members 61 of upper and lower bands 60, 160, as shown in FIG. 1. Straps 70 respectively secure upper and lower bands 60, 160 to the thigh and calf. Furthermore, straps 70 are adjustable to accommodate different leg sizes and provide a snug fit.

In accordance with one embodiment of the present invention, the muscle strengthening device is configured as an automated powered active assist device. In this regard, it is contemplated that various types of drive mechanisms can be implemented to drive rotation of distal limb section 130 relative to proximal limb section 30. According to this embodiment, brace 20 may be adapted for use with wide range of actuators, including, but not limited to those actuators illustrated herein. The actuators may provide overloading and assistive forces.

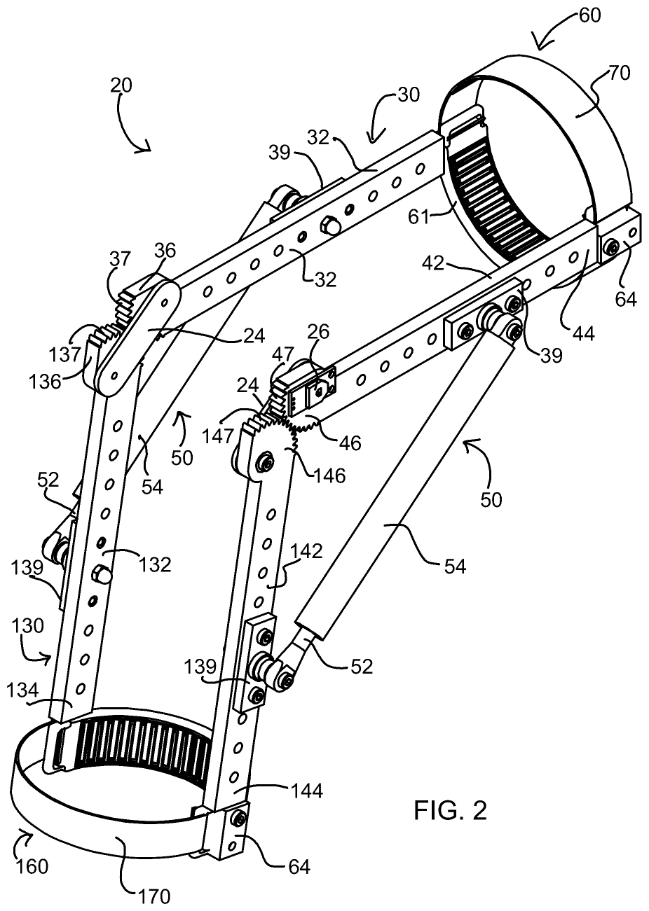

Referring now to FIG. 2, there is shown an embodiment of the present invention that includes a drive mechanism in the form of a powered linear actuator. The illustrated drive mechanism includes an electric linear actuator 50 comprised of a piston 52 and a cylinder 54, wherein an electric motor is housed inside cylinder 54 to move piston 52 between a retracted position and an extended position.

Mounting plates 39 are attached to links 32, 42, 132, and 142. In this regard, links 32, 42, 132, 142 include a plurality of equally-spaced mounting holes according to the illustrated embodiment of the present invention. The mounting holes are dimensioned to receive fasteners (e.g., socket head bolts) to attach respective mounting plates 39 to links 32, 42, 132, 142. The equally spaced mounting holes allows flexibility in the positioning of mounting plates 39. Opposite ends of each linear actuator 50 are pivotally connected to respective mounting plates 39, as shown in FIG. 2. In this regard, a first linear actuator 50 is attached to links 32 and 132, while a second linear actuator 50 is attached to links 42 and 142. It should be appreciated that actuator 50 may be provided on the lateral side, the medial side, or on both sides of brace 20.

As indicated above, linear actuator 50 includes an electric motor to drive piston 52 between retracted and extended positions. Movement of piston 52 between retracted and extended positions changes the angle between proximal limb section 30 and distal limb section 130. Accordingly, movement of piston 52 allows for controlled bending and extension of brace 20.

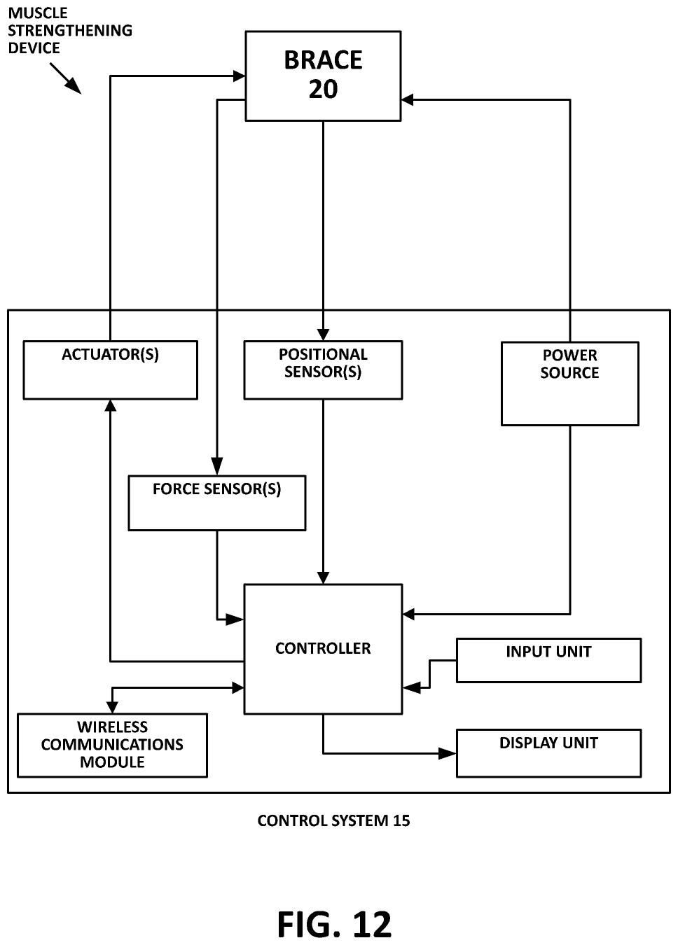

A control system 15 for the muscle strengthening device according to the embodiment of the present invention shown in FIG. 2 will now be described with reference to the block diagram shown in FIG. 12. Control system 15 is generally comprised of at least one actuator, at least one positional sensor, at least one force sensor, a controller, and a power source.

The actuators may take a variety of forms, including but not limited to, an electric linear actuator having a piston and cylinder (as shown in FIG. 2), an in-line actuator, a servomotor, a stepper motor, a DC motor, and the like.

The force sensors may take a variety of forms, including but not limited to, a force transducer, a load cell, a force sensing capacitor, a force sensing resistor, (FSR), and the like. It is contemplated that a force sensor may be attached to the anterior or posterior portion of strap 70 of proximal limb section 30. These force sensors can measure eccentric muscle strength (i.e., eccentric quadriceps strength and eccentric hamstring strength). It is also contemplated that a force sensor may be attached to anterior or posterior portions of strap 170 of distal limb section 130. The force sensors may also function to help guide and motivate a user during exercises through biofeedback. This feedback may in the form of graphical data or used in connection with a motivational game. It should be appreciated that a force sensor may also be integrated into an actuator.

The positional sensors may take a variety of forms, including but not limited to, an accelerometer, rheostat, encoder, and a linear variable differential transformer (LDVT). One or more accelerometers may be located on the proximal limb section 30 and/or the distal limb section 130 to measure limb position. For example, an accelerometer may be configured to: measure the position of the thigh in relation to the horizontal plane, verify the correct position of distal limb section 130 of brace 20 based on a selected exercise, and determine that the limb is positioned correctly with respect to all three planes of movement. Start and stop angles may be selected for a desired range of motion for an exercise. This may also be achieved with length sensors, joint angle sensors, and/or digital protractors/goniometers. In the embodiment of the present invention shown in FIG. 2, an accelerometer 26 is mounted at lower end 46 of upper link 42 of proximal limb section 30.

It is contemplated that a rheostat or encoder may be located at the flexion-extension joint of brace 20. A LVDT is an electromechanical transducer that converts rectilinear motion of an object to which it is coupled mechanically into a corresponding electrical signal. It is contemplated that LVDT may be positioned at one extremity of brace 20, connected to the flexion-extension joint of brace 20.

The controller may take the form of a conventional microcontroller, such as an Arduino Uno. The controller is programmed to control a wide variety of functions. For example, the controller may be programmed to modulate the force or position of the actuators. For example, the controller may regulate movement of an actuator driven by an electric motor, in accordance with user inputs or pre-programmed settings. Electrical signals from the controller control operation of the actuator's electric motor, thereby enabling precise adjustments to the position and angle of distal limb section 130 relative to proximal limb section 30. As a result, the user has the ability to perform eccentric or concentric isokinetic exercises using the muscle strengthening device of the present invention. Furthermore, the controller can receive feedback data from positional sensors (e.g., accelerometers), force sensors, and any other sensors of the muscle strengthening device, to allow brace 20 to dynamically adapt to conditions, thereby providing optimal support whether the user is stationary or in motion.

The controller may be programmed to use data received from the available sensors to activate or deactivate operation of actuators, vary the torque applied by the actuators or the speed/distance in which the actuators act, and display feedback data to the user on a display unit. In this manner, the controller can operate in accordance with an exercise program or user settings. Furthermore, the controller may be programmed to provide a progressive challenge to user at safe speeds and loads by adjusting the amount of delay in-between incremental movement of a servo motor or the stroke speed of a linear actuator.

It is contemplated that the controller, along with an associated display unit and an input unit, may allow a user to select a muscle group they desire to exercise, select a range of degrees for the angle of movement between distal limb section 130 and proximal limb section 30, compare performance to age and sex-matched normative data, view graphical information that provide motivation to a user, allow a clinician to track progress and confirm completion of a set of stored exercise tasks, and provide information on weekly user performance. The controller may also be programmed to control operation of the actuator in accordance with a pre-selected number of sets/repetitions to avoid overuse of the muscle strengthening device. If brace 20 is locked in a position, such as at 60 degrees of knee flexion, the controller may be programmed to collect data on isometric strength for normative and limb symmetry comparisons. The input unit may be used by a user to input additional information including rating of perceived exertion and pain for remote monitoring and safety.

The power source provides power to components of the muscle strengthening device, and may take the form of a rechargeable battery or an AC mains supply (via a power cord). It is contemplated that the battery or socket (for receiving the power cord for connection to AC mains supply) is mounted to a link of brace 20.

In addition to the foregoing, control system 15 may also include a wireless communications module to transmit and receive data between the controller and a conventional smartphone. For example, data may be communicated wirelessly using Bluetooth or Wi-Fi communication protocols. It is contemplated that the smartphone may run a companion application that can provide a visual display of the data, save data, receive user inputs to the controller, and program the controller with pre-programmed actions, exercises, and measurements.

Furthermore, control system 15 may also include additional safety components, including, but not limited to a pinch point sensor for sensing a pinch point, a microphone to sense patient discomfort or pain during use of the muscle strengthening device, and a user-accessible kill switch to deactivate the muscle strengthening device. Moreover, data received by the controller from the force sensors can be used to deactivate power to the muscle strengthening device in the event that a predetermined user-applied force is sensed, or excessive muscle fatigue is sensed.

It is contemplated that one or more components of control system 15 may be mounted to brace 20, or be located in a housing (not shown) remote from brace 20.

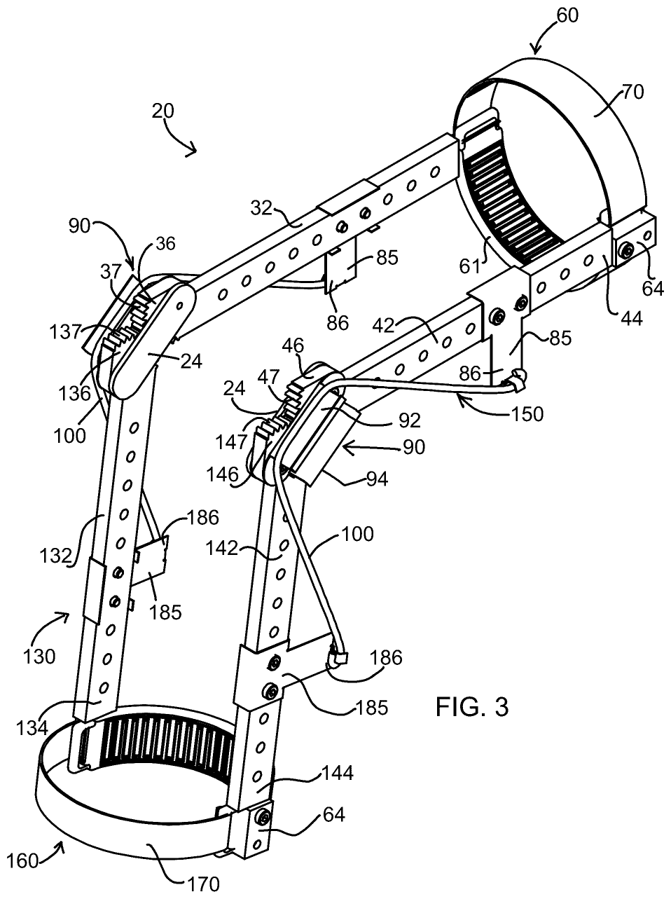

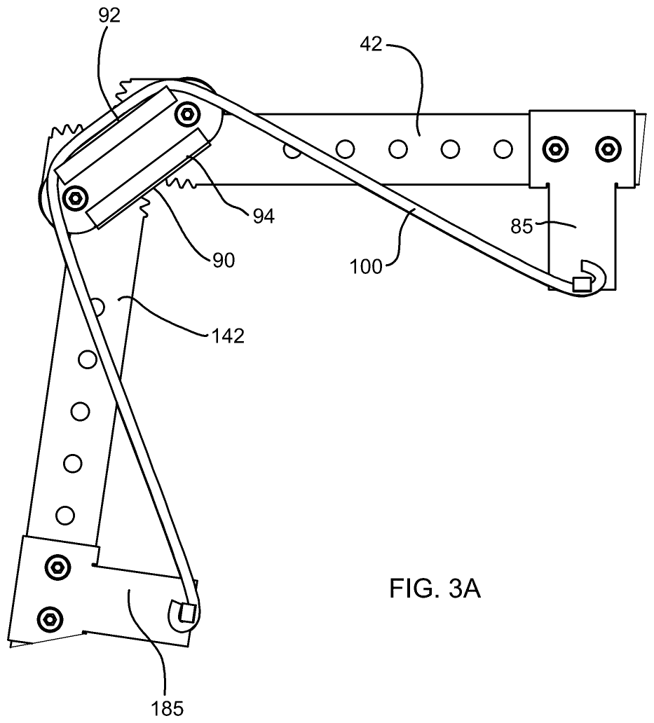

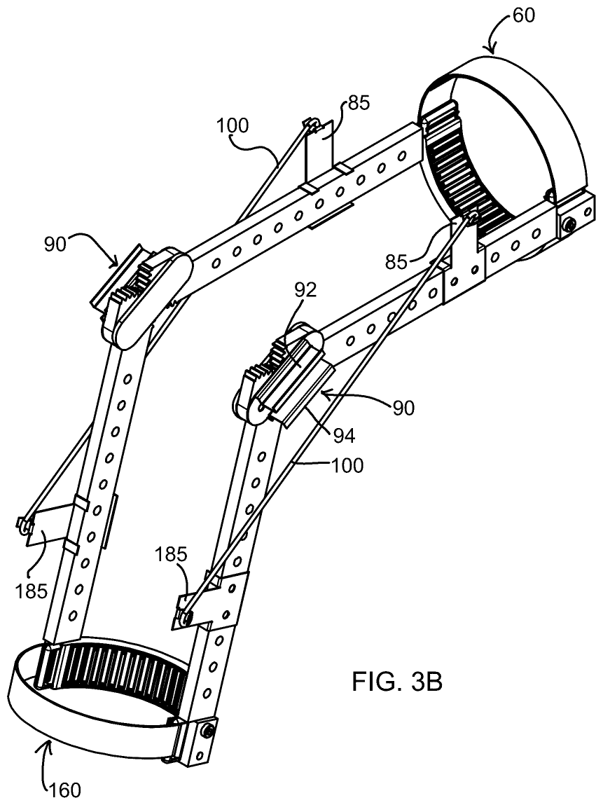

Referring now to FIG. 3, there is shown an embodiment of the present invention that includes a drive mechanism in the form of a manual mechanical actuator, and more specifically an clastic actuator for providing an active elastic assistance for brace 20. In this embodiment, an anchor arm is mounted to each link 32, 42, 132, and 142. Upper anchor arms 85 are mounted to upper links 32 and 42 of proximal limb section 30. Lower anchor arms 185 are mounted to lower links 132 and 142 of distal limb section 130. A first band guide 90 is mounted to lower end 36 of upper link 32 and to upper end 136 of lower link 132. Similarly a second band guide 90 is mounted to lower end 46 of upper link 42 and to upper end 146 of lower link 142, as best seen in FIG. 3A. First and second band guides are mounted such that upper links 32, 42 of proximal limb section 30 are rotatable relative to lower links 132, 142 of distal limb section 130. Band guide includes an upper support surface 92 and a lower support surface 94, as best seen in FIG. 3A.

This embodiment of the present invention includes two elastic bands 100 (e.g., rubber bands). A first elastic band 100 is arranged on upper link 32 and lower link 132 in the following manner. A first end of the first elastic band 100 is attached to a distal end 86 of an upper anchor arm 85, and a second end of the first elastic band 100 is attached to a distal end 186 of a lower anchor arm 185. A central portion of the first elastic band 100 is supported on upper support surface 92 of band guide 90. A second elastic band 100 is arranged in the same manner in connection with upper link 42 and lower link 142. Tension in clastic bands 100 provides the force for active assistance. As the knee is moved, clastic bands 100 stretch and contract to help control and support movement of the knee joint.

It should be appreciated that the equally spaced mounting holes in links 32, 42, 132 and 142 provide flexibility in positioning and ensuring optimal tension and support from clastic bands 100. Band guides 90 provide an upper support surface 92 that guides elastic bands 100, thereby allowing for additional stretch and controlled assistance.

In an alternative embodiment shown in FIG. 3B, the orientation of upper and lower anchor arms 85, 185 are reversed. Orientation of upper and lower anchor arms 85, 185 determines whether brace 20 is configured for extension motion or flexion motion of the knee joint. In this alternative embodiment, band 100 is mounted such that it engages with lower support surface 94 of band guide 90.

In addition to the actuators described above with respect to the embodiments shown in FIGS. 2 and 3, it is contemplated that suitable actuators for the present invention may also include a linear actuator that converts linear motion into rotational motion with controllable force and vice versa. Examples of such linear actuator include a mechanical actuator comprised of a screw and cochlea where either is actuated by an electric motor; a hydraulic piston whose position is controlled by a volume of hydraulic fluid, where the resistance is controlled by a magnetorheological fluid (“smart fluid”); and a pneumatic piston whose force is controlled by the pressure of a gas. Other contemplated electrical powered actuators include an in-line actuator, a servomotor, a stepper motor, and a DC motor.

Actuators may also take the form of a set of elastic bands whose force is controlled by a set of cams, a bellows mechanism that converts the pressure of a gas into torque at the joint where the proximal limb section and distal limb section are pivotally joined, and a gear rack mechanism where the rotation of a motor causes rotation of distal limb section 130 relative to proximal limb section 30.

In summary, the present invention may be adapted for a variety of actuators, including mechanical, hydraulic, pneumatic, and clastic systems, which convert motions and control forces with high precision.

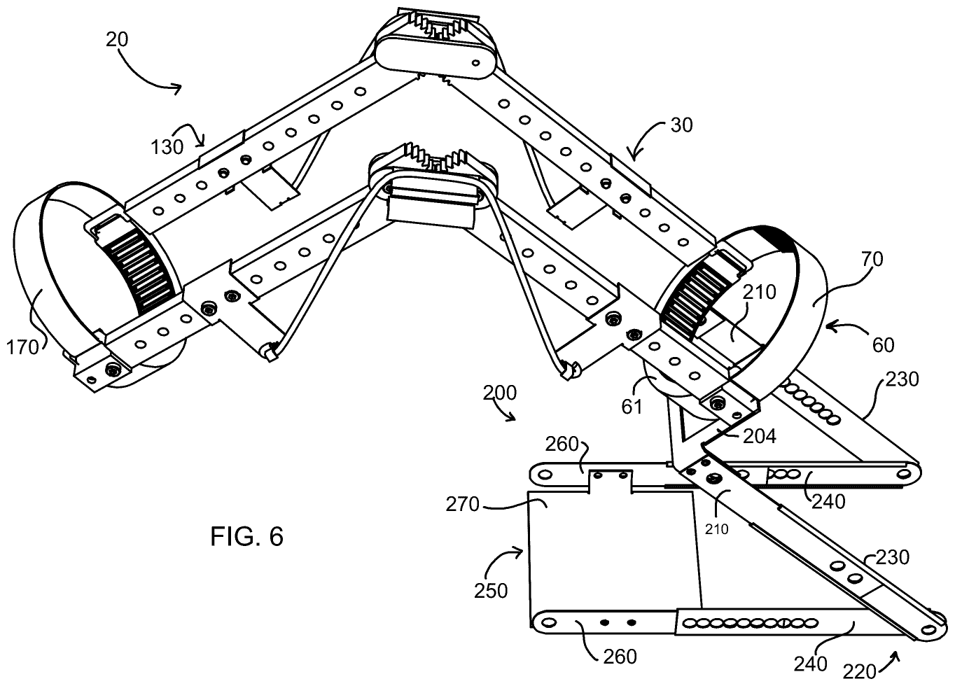

Referring now to FIG. 6-8 a tilting device 200 will be described in detail. Tilting device 200 is an optional component of the muscle strengthening device which is attachable to support member 61 of upper band 60, as shown in FIG. 6. A function of tilting device 200 is to allow a user elevate their leg at a desired angle (e.g., 35-45 degrees above the horizontal) for comfort and usability of the muscle strengthening device. The user may be in a sitting position or another position requiring leg elevation. Tilting device 200 allows a user to prop the leg up to provide the correct positioning at the hip to allow for lengthened-state eccentric training for hamstring muscles.

Tilting device 200 is generally comprised of a mounting member 202, a pivoting receiving element 220, and a support element 250.

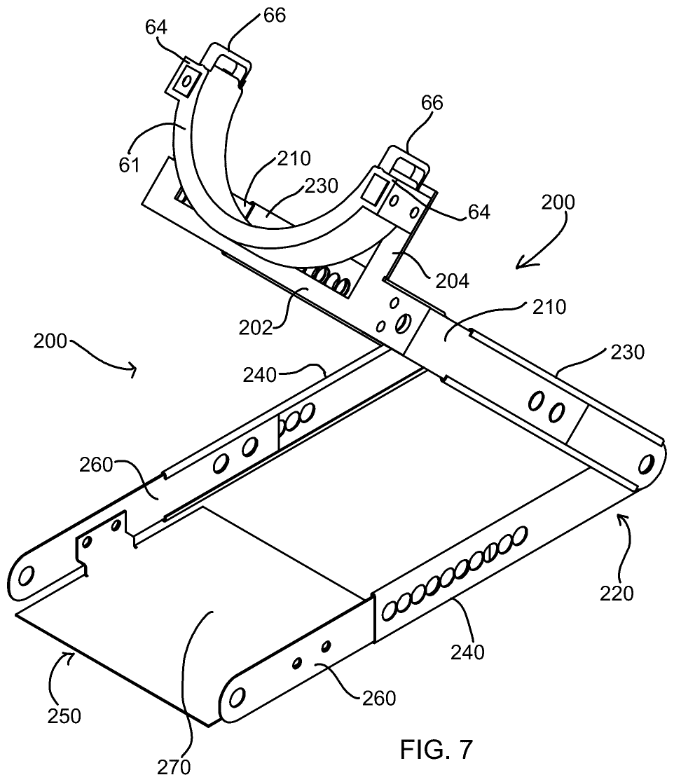

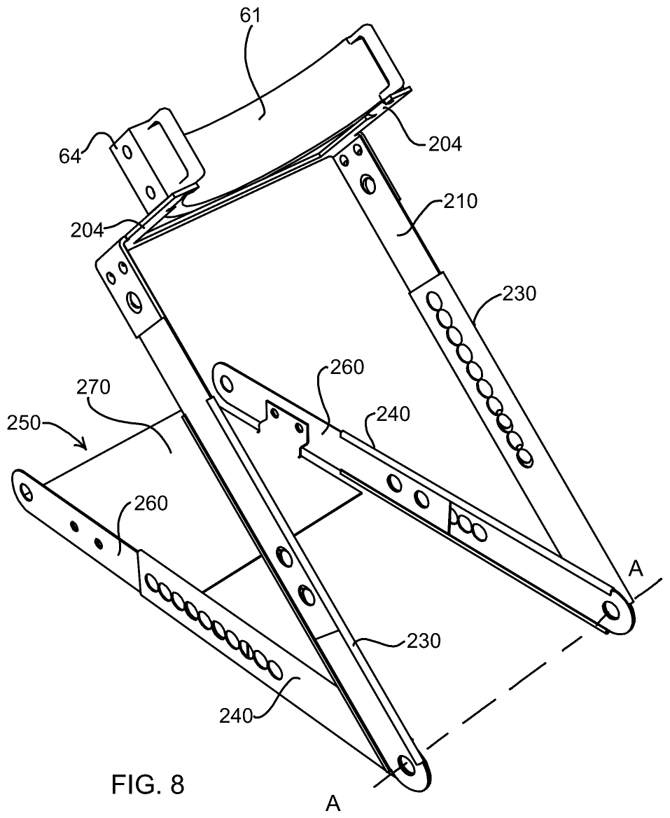

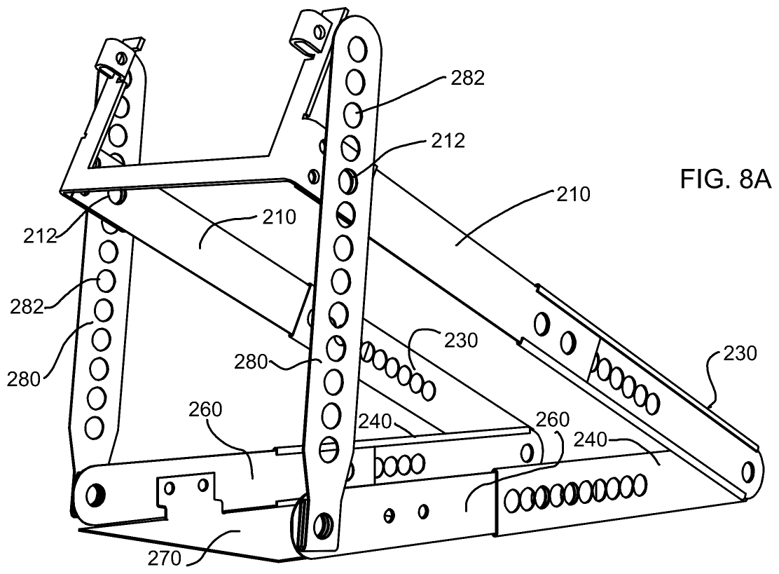

Mounting member 202 includes a pair of fingers 204 that are fixed to respective receiving portions 64 of support member 61 of upper band 60 (best seen in FIGS. 7 and 8), and a pair of outward-extending elongated upper sliding arms 210. Mounting member 202 securely connects to upper band 60 to allow for the transmission of movement and support from upper band 60 to tilting device 200.

Receiving element 220 includes a pair of elongated upper receiving arms 230 and a pair of elongated lower receiving arms 240. Upper receiving arms 230 are pivotally connected to respective lower receiving arms 240. Upper receiving arms 230 and lower receiving arms 240 pivot about an axis A-A, shown in FIG. 8.

Support element 250 includes a pair of elongated lower sliding arms 260 and a base plate 270 extending between the lower sliding arms 260. The pair of lower sliding arms 260 are connected to opposite sides of base plate 270, as seen in FIGS. 6-8. During use, base plate 270 is placed on a stable, generally planar, surface (e.g., a support surface of a chair).

Upper sliding arms 210 are dimensioned to be received in an elongated slot of upper receiving arms 230. Similarly, lower sliding arms 260 are dimensioned to be received in an elongated slot of lower receiving arms 240. Extension and retraction of upper sliding arms 210 and lower sliding arms 260 allows adjustment in the length between upper band 60 and the user's hip (i.e., variations in band-to-hip distance).

In one embodiment, tilting device 200 may also include a locking element comprising a pair of elongated links 280, having a plurality of openings or slots 282, which are pivotally mounted at the distal ends of lower sliding arms 260. The pair of elongated links 280 are rotated to a desired position, and pins are extended through a slot 282 in links 280 and a hole 212 formed in sliding arms 210 to lock the position of tilting device 200. This locking element allows a user to secure tilting device 200 at a desired angle. This ensures that once a desired angle and position are set, tilting device 200 remains stable and provides consistent support for brace 20 at the desired angle.

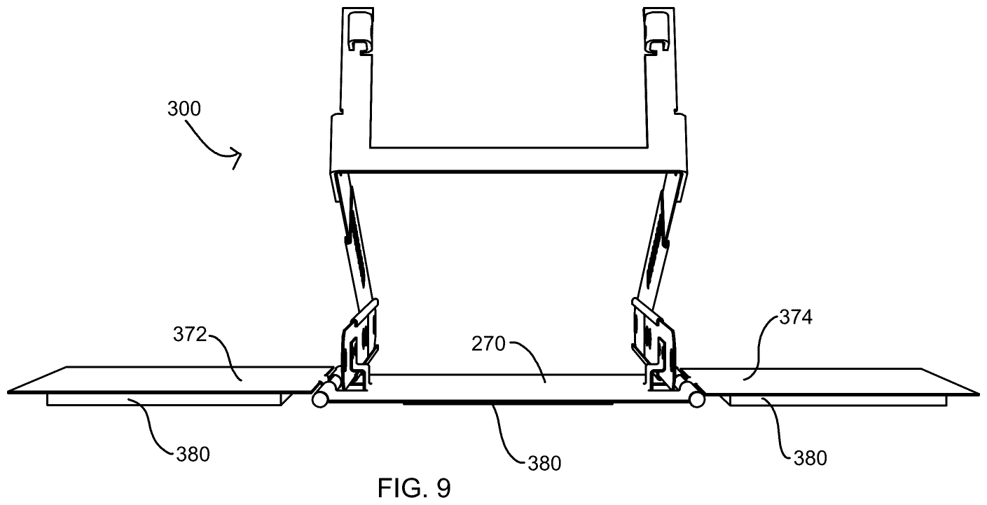

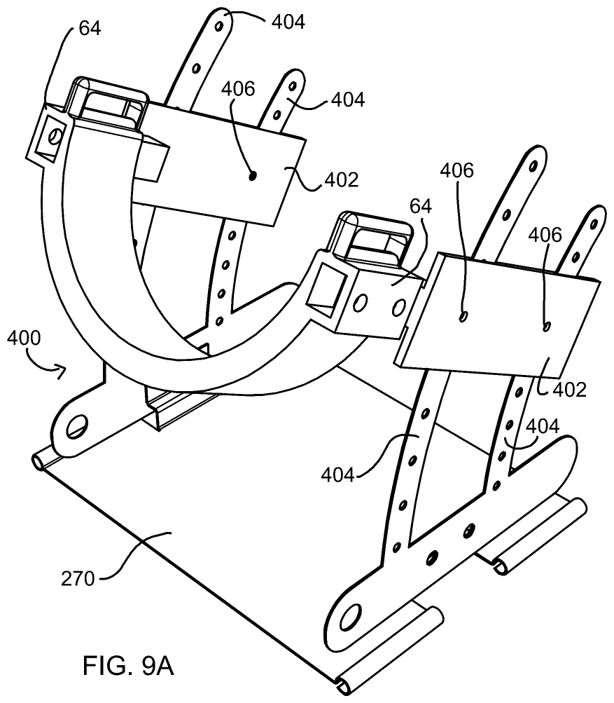

FIG. 9 shows a tilting device 300, which is an alternative embodiment of tilting device 200 shown in FIGS. 6-8. Tilting device 300 includes a pair of lateral hinged flaps 372 and 374 that are pivotally attached to base plate 270. Flaps 372 and 374 can be folded for storage or unfolded (as shown in FIG. 9) to provide an enlarged support surface for the tilting device. Padding 380 is located on the lower surface of base plate 270 and flaps 372, 374.

FIG. 9A shows a tilting device 400 according to another alternative embodiment. In this embodiment, each receiving portion 64 is attached to a sliding member 402. Each sliding member 402 slides on a set of concentric pair of curved slotted rails 404, which allow tilting device 400 to change the angle of brace 20 by fixed increments (e.g., 5 degrees) per slot. Sliding members 402 are locked in position by pins extending through openings 406 in sliding member 402 and the slots of rails 404. Each pair of curved sliding members 402 is attached to opposite sides of base plate 270.

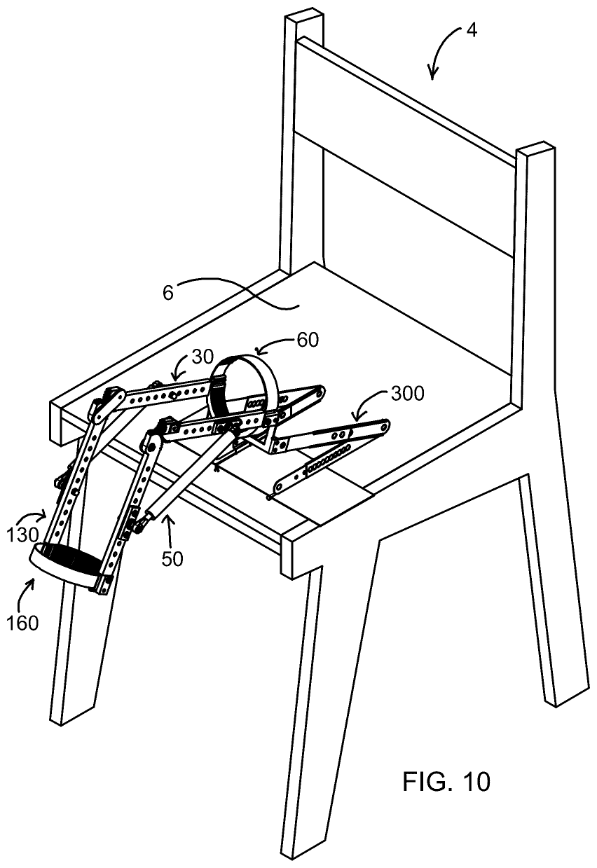

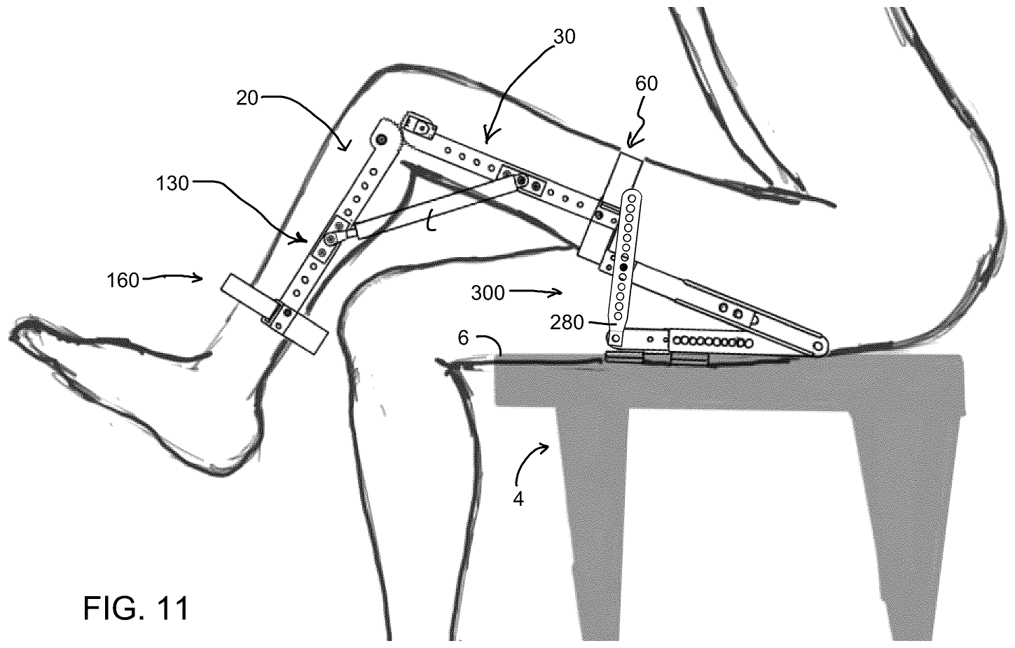

Referring now to FIG. 10, there is shown the muscle strengthening device with actuator 50 and tilting device 300 as mounted on the generally planar support surface 6 of a chair 4. FIG. 11 shows the muscle strengthening device of FIG. 10 with brace 20 coupled to a user's leg. The user is seated on support surface 6 of chair 4 with base plate 270 and hinged flaps 372, 374 located on support surface 6 under the user.

It is contemplated that the muscle strengthening device may also include a bolster or wedge to place the thigh at 40 degrees above the horizontal line while seated. This position appears in rehabilitation protocol reference literature in regard to lengthened state eccentric exercises for the hamstring. The bolster or wedge may be configured with angles of different degree increments progressing to 40 degrees.

It is further contemplated that the actuator and the tilting device of the present invention may be adapted for attachment to an existing brace, and may include a quick release type mechanism to facilitate attachment/detachment therefrom.

In summary, the present invention is directed to a muscle strengthening device that includes a brace for supporting and controlling limb or spine movements through adjustable mechanical structures and an actuator. Components of the muscle strengthening device allow for flexion-extension, prono-supination, and internal-external rotation movements. The angle of inclination that the proximal segment of a limb is in is controlled by an adjusted structure to allow for muscles to be exercised in a lengthened state. These movements are facilitated by gear joints, concentric cylinders, and a variety of actuators including mechanical, hydraulic, pneumatic, and elastic systems, which convert motions and control forces with high precision. Additionally, the muscle strengthening device includes a control system having a controller for modulating actuator force and position, as well as a wireless communications module that can be interfaced with a smartphone. This allows for real-time feedback, data visualization, and the ability to configure predefined therapeutic exercises or measurements through a smartphone app. The controller may be programmed to provide a resistive force for training or an assisting force for rehabilitation. Accordingly, the muscle strengthening device of the present invention is adaptive to a wide variety of needs.

The foregoing describes specific embodiments of the present invention. It should be appreciated that these embodiments are described for purposes of illustration only, and that numerous alterations and modifications may be practiced by those skilled in the art without departing from the spirit and scope of the invention. In this regard, it should be appreciated that while the muscle strengthening device of the present invention has been described herein for use with a leg, it is also contemplated that the muscle strengthening device may also be adapted for use with an arm. It is intended that all such modifications and alterations be included insofar as they come within the scope of the invention as claimed or the equivalents thereof.

What is claimed is:

1. A muscle strengthening device comprising:
a brace including:
a proximal limb section including an upper band adapted to attach to a user's limb, and
a distal limb section including a lower band adapted to attach to a user's limb, wherein the distal limb section is pivotally connected with the proximal limb section; and
at least one actuator for moving the distal limb section relative to the proximal limb section.

2. The muscle strengthening device of claim 1, wherein
the proximal limb section includes a first cam portion having gear teeth, and
the distal limb section includes a second cam portion having gear teeth, wherein the gear teeth of the second cam portion meets with the gear teeth of the first cam portion.

3. The muscle strengthening device of claim 1, wherein the proximal and distal limb sections are each respectively comprised of a pair of links, wherein lower ends of the pair of links of the proximal limb section are pivotally connected to respective upper end of the pair of links of the distal limb section.

4. The muscle strengthening device of claim 3, wherein the proximal and distal limb sections include respective cam portions having gear teeth formed thereon.

5. The muscle strengthening device of claim 3, wherein at least one link of the proximal limb section and at least one link of the distal limb section includes one or more mounting holes for mounting the at least one actuator to the proximal and distal limb sections.

6. The muscle strengthening device of claim 5, wherein said device further comprises at least one pair of mounting plates that are attached at mounting holes by fasteners, said at least one actuator attached to the mounting plates.

7. The muscle strengthening device of claim 1, wherein the upper band includes a support member and a strap for encircling an upper portion a user's limb to secure the proximal limb section thereto.

8. The muscle strengthening device of claim 1, wherein the lower band includes a support member and a strap for encircling a lower portion of a user's limb to secure the distal limb section thereto.

9. The muscle strengthening device of claim 1, wherein the at least one actuator includes an electric cylinder having a piston and cylinder, said piston movable between a retracted position and an extended position to move the distal limb section relative to the proximal limb section, thereby changing the angle therebetween.

10. The muscle strengthening device of claim 1, wherein the at least one actuator includes an elastic band.

11. The muscle strengthening device of claim 1, wherein the device further comprises:
a controller for controlling the operation of the actuator.

12. The muscle strengthening device of claim 1, wherein the device further comprises:
at least one positional sensor.

13. The muscle strengthening device of claim 12, wherein the at least one positional sensor is an accelerometer.

14. The muscle strengthening device of claim 1, wherein the device further comprises at least one force sensor.

15. The muscle strengthening device of claim 1, wherein the device further comprises a tilting device for modifying the angle of the brace relative to a generally planar support surface.

16. The muscle strengthening device of claim 15, wherein the tilting device comprises a pivoting receiving element, including:
a pair of upper sliding arms;
a pair of lower sliding arms pivotally attached to the pair of upper sliding arms;
a pair of upper receiving arms dimensioned to receive the pair of upper sliding arms;
a pair of lower receiving arms dimensioned to receive the pair of lower sliding arms;
a base plate extending between the pair of lower sliding arms; and
a mounting member for mounting the tilting device to the brace.

17. The muscle strengthening device of claim 16, wherein the base plate includes a pair of folding flaps.

18. The muscle strengthening device of claim 16, wherein the tilting device further comprises a locking element for securing the tilting device at a desired angle.
